(19) United States
(12) Patent Application Publication
(10) Pub. No.: US 2026/0093127 A1
(43) Pub. Date: Apr. 2, 2026

(54) LIQUID CRYSTAL DISPLAY DEVICE

(71) Applicant: Japan Display Inc., Tokyo (JP)

(72) Inventors: Masafumi OKADA, Tokyo (JP); Nobuyuki SUZUKI, Tokyo (JP); Takashi OTA, Tokyo (JP)

(73) Assignee: Japan Display Inc., Tokyo (JP)

(21) Appl. No.: 19/321,333

(22) Filed: Sep. 8, 2025

(30) Foreign Application Priority Data
Oct. 1, 2024 (JP) 2024-172147

(51) Int. Cl. G02B 30/32; F21V 8/00; G02F 1/1335; G02F 1/13357

(52) U.S. Cl. CPC G02B 30/32; G02B 6/0016; G02B 6/002; G02B 6/0031; G02F 1/133507; G02F 1/133524; G02F 1/133615

(57) ABSTRACT

A liquid crystal display device includes: a liquid crystal display panel; a parallax barrier that overlaps the liquid crystal display panel, enables a first image to be viewed when the liquid crystal display panel is viewed in a first direction, and enables a second image different from the first image to be viewed when the liquid crystal display panel is viewed in a second direction different from the first direction; and a backlight on a rear side of the liquid crystal display panel. The first direction is a normal direction of the liquid crystal display panel. The backlight includes a light guide plate and a light source. Light emitted from the backlight to the liquid crystal display panel has a peak of luminance within a range of 5° from the first direction and a peak of luminance within a range of 5° from the second direction.

### CROSS-REFERENCE TO RELATED APPLICATION

This application claims priority to Japanese Patent Application No. 2024-172147 filed on Oct. 1, 2024, the entire contents of which are incorporated by reference herein.

### BACKGROUND OF THE INVENTION

The present invention relates to a liquid crystal display device.

One of techniques for liquid crystal display devices is a technique that enables two different images to be viewed depending on viewing directions using one liquid crystal display panel.

Examples of documents regarding such a technique include Japanese Unexamined Patent Application Publication No. 2006-330018. FIGS. 2 and 3 and Summary of Japanese Unexamined Patent Application Publication No. 2006-330018 indicate that the same person can view two different images using one display, a “multi-view display” capable of providing large, easy-to-view images is provided for viewing the images, a first pixel group (24) of pixels arranged in a horizontal direction and driven by a first image signal, and a second pixel group (25) of pixels arranged in the horizontal direction and driven by a second image signal are alternately arranged in a vertical direction, a parallax barrier (23) is provided, which splits the direction of light vertically such that light from the first pixel group (24) reaches a first viewing region (26) (driver's seat side) and light from the second pixel group (25) reaches a second viewing region (27) (windshield), and two different images are projected vertically such that one driver can view the two different images displayed in a large size on one display screen.

### SUMMARY OF THE INVENTION

However, in the technique described in Japanese Unexamined Patent Application Publication No. 2006-330018, as illustrated in FIGS. 2 and 3, it is assumed that images are viewed not in a normal direction of a dual view display (5) but in an oblique direction having a predetermined angle with respect to the normal direction of the dual view display (5). Therefore, when the first viewing region (26) (the driver's seat side) is directly viewed, it is necessary to view it in the oblique direction rather than from directly in front of the dual view display (5), which poses a problem that it is not possible to view it from directly in front of the dual view display (5).

An object of the present invention is to provide a thin liquid crystal display device that enables two different images to be viewed from the front of a single liquid crystal display panel and from an oblique direction with respect to the liquid crystal display panel, and has high efficiency in using light of a backlight.

To solve the above-described problems, a liquid crystal display device according to the present invention includes a liquid crystal display panel, a parallax barrier that is disposed so as to overlap the liquid crystal display panel, enables a first image to be viewed when the liquid crystal display panel is viewed in a first direction, and enables a second image different from the first image to be viewed when the liquid crystal display panel is viewed in a second direction different from the first direction, and a backlight disposed on a rear side of the liquid crystal display panel. The first direction is a normal direction of the liquid crystal display panel. The backlight includes a light guide plate and a light source that causes the light to enter from a side surface of the light guide plate. The light emitted from the backlight to the liquid crystal display panel has a peak of luminance within a range of 5° from the first direction and a peak of luminance within a range of 5° from the second direction.

According to the present invention, a thin liquid crystal display device can be implemented, which enables two different images to be viewed from the front of a single liquid crystal display panel and from an oblique direction with respect to the liquid crystal display panel, and has high efficiency in using light of a backlight.

### BRIEF DESCRIPTION OF THE DRAWINGS

FIG. 1 is a sectional view of a liquid crystal display device according to an embodiment;

FIG. 2 is a top view of a backlight according to the embodiment;

FIG. 3 is a sectional view taken along line A-A illustrated in FIG. 2;

FIG. 4 is a sectional view taken along line B-B illustrated in FIG. 2;

FIG. 5 is a sectional view for explaining a configuration of a second lens film according to the embodiment;

FIG. 6 is a diagram illustrating an example of a luminance distribution of a backlight according to a comparative example;

FIG. 7 is a diagram illustrating a first example of a luminance distribution of the backlight according to the embodiment;

FIG. 8 is a diagram illustrating a second example of a luminance distribution of the backlight according to the embodiment; and

FIG. 9 is a diagram illustrating a third example of a luminance distribution of the backlight according to the embodiment.

### DETAILED DESCRIPTION OF THE PREFERRED EMBODIMENTS

Hereinafter, embodiments of the present invention are described with reference to the drawings. In each of the drawings and the embodiments, the same or similar components are denoted by the same reference signs, and duplicated explanations are omitted.

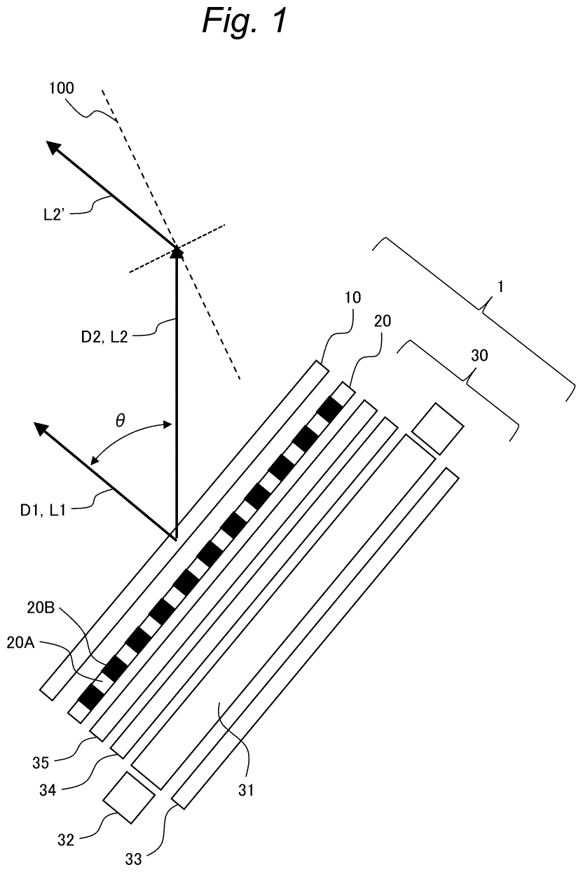

FIG. 1 is a sectional view of a liquid crystal display device according to an embodiment.

In the present embodiment, it is assumed that the liquid crystal display device is an in-vehicle liquid crystal display device 1. The embodiment will be described using an example in which a driver, who is a viewer, can view different images when the driver directly views the liquid crystal display device 1 and when the driver views an image reflected by a reflector 100 such as a windshield. The in-vehicle liquid crystal display device 1 is not limited thereto and may be used for other purposes.

The liquid crystal display device 1 according to the present embodiment includes a liquid crystal display panel 10, a parallax barrier 20, and a backlight 30.

The liquid crystal display panel 10 may be a general liquid crystal display panel.

The backlight 30 is disposed on a rear side of the liquid crystal display panel 10. The backlight 30 according to the present embodiment will be described later in detail.

The parallax barrier 20 is disposed so as to overlap the liquid crystal display panel 10. The parallax barrier 20 enables a first image to be viewed when the liquid crystal display panel 10 is viewed in a first direction D1, and enables a second image different from the first image to be viewed when the liquid crystal display panel 10 is viewed in a second direction D2 different from the first direction D1.

In the present embodiment, the parallax barrier 20 is disposed on the rear side of the liquid crystal display panel 10. However, the parallax barrier 20 is not limited thereto, and may be disposed on a front side of the liquid crystal display panel 10.

In the present embodiment, it is assumed that the liquid crystal display device 1 is fixed at an angle of 60° with respect to a horizontal direction, and that the second direction D2 is an upward direction with respect to the first direction D1. Therefore, in the parallax barrier 20, a transmission region 20A extending in a left-right direction and a shielding region 20B extending in the left-right direction are alternately arranged in a vertical direction.

In the liquid crystal display panel 10, a first pixel region disposed to display the first image and extending in the left-right direction and a second pixel region disposed to display the second image and extending in the left-right direction are alternately arranged in the vertical direction such that the arrangement of the first pixel region and the second pixel region corresponds to the arrangement of the transmission region 20A and the shielding region 20B of the parallax barrier 20. Light emitted from the backlight 30 in the first direction D1 passes through the transmission region 20A of the parallax barrier 20 and the first pixel region and is viewed as first light L1, but light emitted from the backlight 30 in the first direction D1 is shielded by the shielding region 20B, does not reach the second pixel region, and is not included in the first light L1. Similarly, light emitted from the backlight 30 in the second direction D2 passes through the transmission region 20A of the parallax barrier 20 and the second pixel region and is viewed as second light L2, but light emitted from the backlight 30 in the second direction D2 is shielded by the shielding region 20B, does not reach the first pixel region, and is not included in the second light L2. Therefore, although the resolution is halved, the first image can be viewed when the liquid crystal display panel 10 is viewed in the first direction D1, and the second image can be viewed when the liquid crystal display panel 10 is viewed in the second direction D2.

The first light L1 output from the liquid crystal display panel 10 in the first direction D1 is directly viewed by the viewer. Meanwhile, the second light L2 output from the liquid crystal display panel 10 in the second direction D2 is fully reflected by the reflector 100 to become reflected light L2′ and the reflected light L2′ is indirectly viewed by the viewer. When the first image and the second image are viewed by the viewer, the first image appears to be displayed directly on the liquid crystal display panel 10, and the second image appears to be displayed on the reflector 100 such as a windshield. As the first image, for example, at least one of gauges such as speedometers can be displayed. As the second image, for example, at least one of abnormality warnings, maps, traffic information, and the like can be displayed.

In the present embodiment, the first direction D1 is the normal direction of the liquid crystal display panel 10. Therefore, when the viewer directly views the liquid crystal display panel 10, the viewer can view an image not from an oblique direction but from the front of the liquid crystal display panel 10, and thus the visibility is high.

It is preferable that an angle θ formed by the first direction D1 and the second direction D2 be in a range of 55° to 65°. Therefore, the second image can be easily projected onto the reflector 100 such as a windshield. However, the angle is not limited thereto and may be another angle.

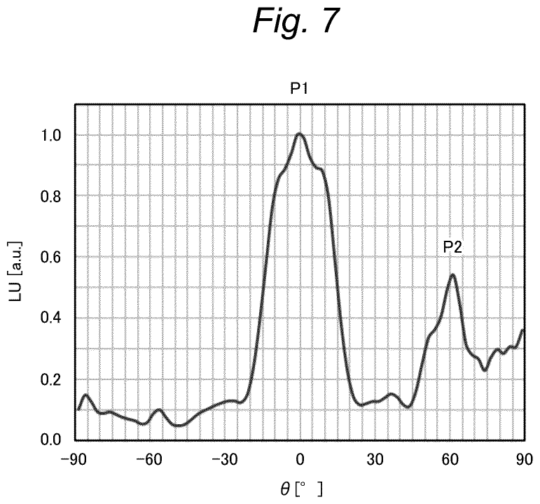

In the present embodiment, as illustrated in FIGS. 7 to 9 described later, light emitted from the backlight 30 to the liquid crystal display panel 10 has peaks (first peak P1 and second peak P2) of luminance LU within a range of 5° from the first direction D1 and within a range of 5° from the second direction D2. Therefore, it is possible to implement the liquid crystal display device 1 that has high efficiency in using light of the backlight 30. In the present embodiment, the light having the peaks of luminance LU indicates that the light emitted from the backlight 30 has directivity and does not include diffused light that does not have directivity and has a small local peak.

Next, the backlight 30 according to the present embodiment will be described in detail.

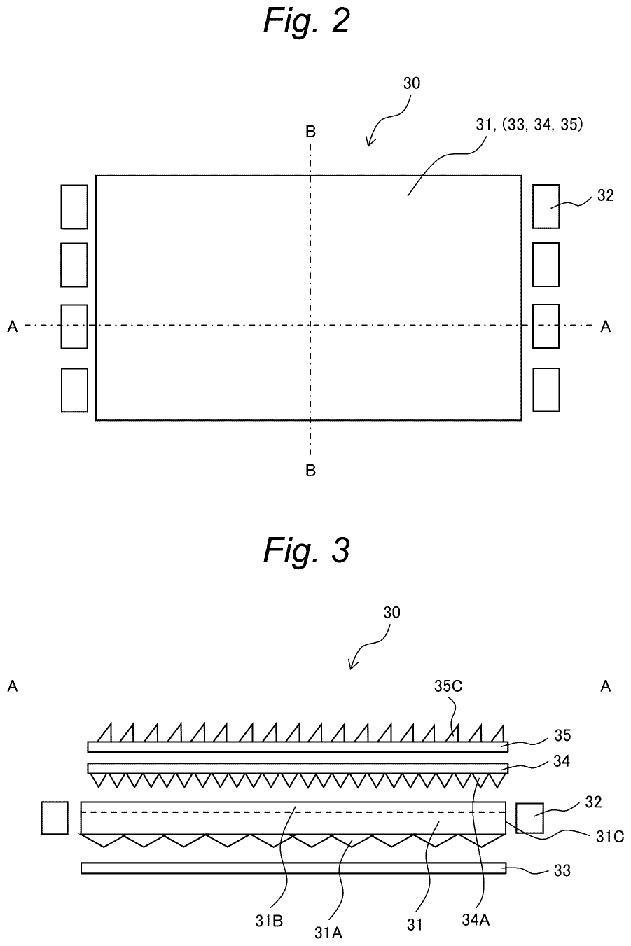

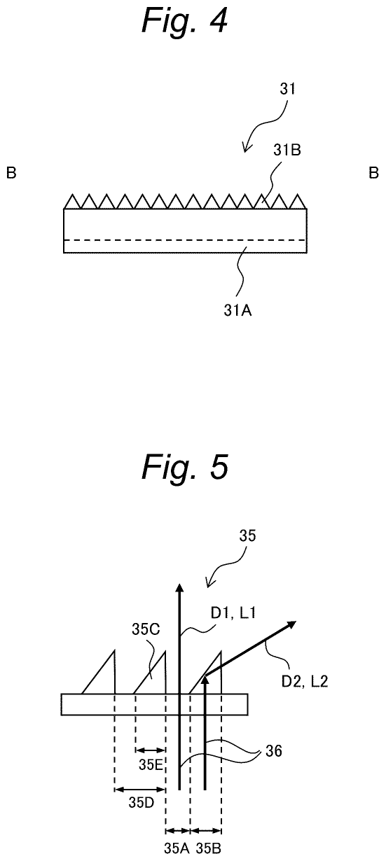

FIG. 2 is a top view of the backlight according to the embodiment. FIG. 3 is a sectional view taken along line A-A illustrated in FIG. 2. FIG. 4 is a sectional view taken along line B-B illustrated in FIG. 2. FIG. 5 is a sectional view for explaining a configuration of a second lens film according to the embodiment.

As illustrated in FIGS. 2 and 3, the backlight 30 according to the present embodiment includes a light guide plate 31 and a light source 32 that causes the light to enter from a side surface 31C of the light guide plate 31. Therefore, the backlight 30 can be made thin and the liquid crystal display device 1 can be made thin.

As illustrated in FIG. 3, the backlight 30 according to the present embodiment further includes a reflective film 33 disposed on the rear side of the light guide plate 31, a first lens film 34 disposed between the light guide plate 31 and the liquid crystal display panel 10, and a second lens film 35 disposed between the first lens film 34 and the liquid crystal display panel 10.

FIG. 2 illustrates the first lens film 34 and the second lens film 35 in a see-through manner so that the light guide plate 31 can be seen. In FIG. 2, the reflective film 33 is hidden behind the light guide plate 31.

As illustrated in FIG. 5, collimated light 36 is output from the first lens film 34. The second lens film 35 includes a first region 35A from which the entered collimated light 36 is output in the first direction D1, and a second region 35B in which a linear prism 35C from which the entered collimated light 36 is output in the second direction D2 is disposed. The first region 35A and the second region 35B are alternately arranged.

It is preferable that the linear prism 35C of the second lens film 35 be disposed on the liquid crystal display panel 10 side, extend along the side surface 31C of the light guide plate 31 from which the light from the light source 32 enters the light guide plate 31, and have a first base angle of 55° to 59° and a second base angle of 83° to 87°, and it is more preferable that the first base angle be 57° and the second base angle be 85°. The first base angle and the second base angle are not limited thereto, and may be changed based on the second direction D2.

It is preferable that the density of the linear prism 35C in the second lens film 35 be in a range of 30% to 70%. The density of the linear prism 35C is the ratio of a prism width 35E to a prism pitch 35D. The prism pitch 35D corresponds to a width obtained by summing a width of the first region 35A and a width of the second region 35B. The prism width 35E corresponds to the width of the second region 35B. As described later with reference to FIGS. 7 to 9, it is possible to adjust the ratio of luminance LU in the first direction D1 to luminance LU in the second direction D2 by changing the density of the linear prism 35C.

Next, a structure for outputting the collimated light 36 from the first lens film 34 will be described.

As illustrated in FIGS. 3 and 4, the light guide plate 31 includes a first linear prism array 31A disposed on the reflective film 33 side and extending along the side surface 31C from which the light from the light source 32 enters the light guide plate 31, and a second linear prism array 31B disposed on the first lens film 34 side and extending in a direction orthogonal to a direction in which the first linear prism array 31A extends.

The first lens film 34 includes a third linear prism array 34A disposed on the light guide plate 31 side and extending along the side surface 31C of the light guide plate 31 from which the light from the light source 32 enters the light guide plate 31.

It is preferable that the first linear prism array 31A have an isosceles triangle shape and have a vertex angle of 174° to 178°. It is more preferable that the first linear prism array 31A have a vertex angle of 176°.

It is preferable that the second linear prism array 31B have an isosceles triangle shape and have a vertex angle of 55° to 65° or a vertex angle of 95° to 100°. It is more preferable that the second linear prism array 31B have a vertex angle of 60°.

It is preferable that the third linear prism array 34A have an isosceles triangle shape and have a vertex angle of 66° to 68°. It is more preferable that the third linear prism array 34A have a vertex angle of 68°.

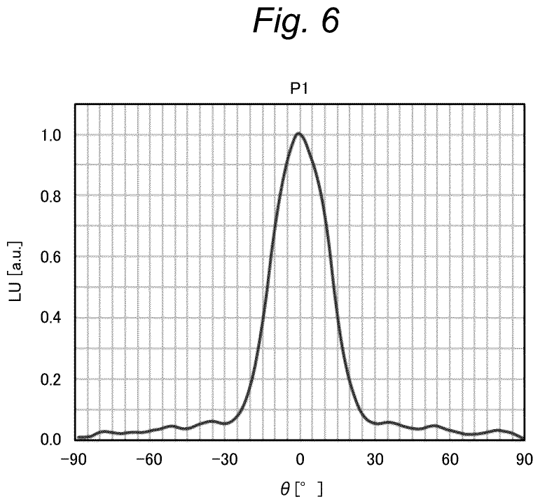

FIG. 6 is a diagram illustrating an example of a luminance distribution of a backlight according to a comparative example.

The backlight 30 according to the comparative example corresponds to a configuration in which the second lens film 35 is removed from the backlight 30 according to the present embodiment.

FIG. 6 illustrates the example of the luminance distribution in a case where a first linear prism array 31A has an isosceles triangle shape with a vertex angle of 176°, a second linear prism array 31B has an isosceles triangle shape with a vertex angle of 60°, and a third linear prism array 34A has an isosceles triangle shape with a vertex angle of 68°. In FIG. 6, the horizontal axis indicates an angle θ [°] formed by the first direction D1 (normal direction) and the second direction D2, and the vertical axis indicates normalized luminance LU [a.u.].

As illustrated in FIG. 6, since the backlight 30 according to the comparative example has a first peak P1 with respect to an angle close to an angle θ=0° corresponding to the first direction D1 (normal direction) and does not have another peak (second peak P2), it can be seen that the backlight 30 according to the comparative example emits collimated light 36 from a first lens film 34.

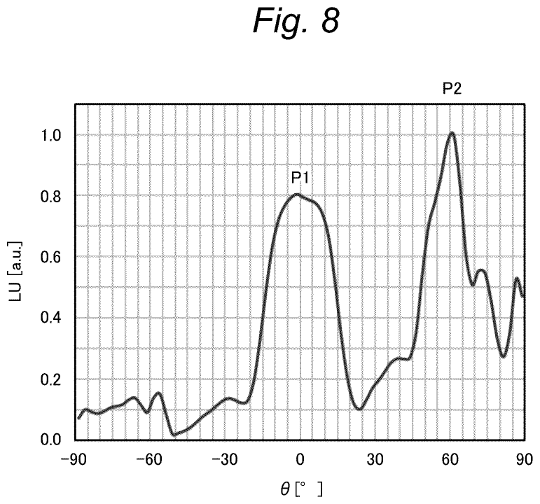

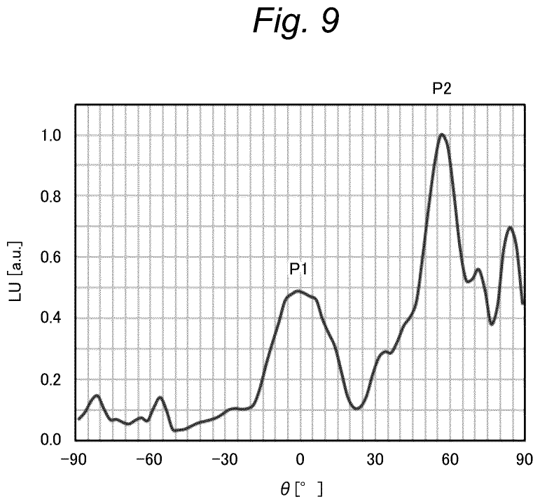

FIG. 7 is a diagram illustrating a first example of a luminance distribution of the backlight according to the embodiment. FIG. 8 is a diagram illustrating a second example of a luminance distribution of the backlight according to the embodiment. FIG. 9 is a diagram illustrating a third example of a luminance distribution of the backlight according to the embodiment. In each of FIGS. 7 to 9, the horizontal axis and the vertical axis indicate the same angle and luminance as those indicated by the horizontal and vertical axes in FIG. 6.

In FIGS. 7 to 9, the shapes of the first linear prism array 31A, the second linear prism array 31B, and the third linear prism array 34A are the same as those of the backlight according to the comparative example that has the luminance distribution illustrated in FIG. 6. The linear prism 35C of the second lens film 35 has a first base angle of 57° and a second base angle of 85°. The density of the linear prism 35C in the second lens film 35 is 30% in FIG. 7, 50% in FIG. 8, and 70% in FIG. 9.

As illustrated in FIGS. 7 to 9, it can be seen that the backlight 30 according to the present embodiment has a first peak P1 with respect to an angle close to an angle θ=0° corresponding to the first direction D1 (normal direction) and has a second peak P2 with respect to an angle close to an angle θ=60° corresponding to the second direction D2. The ratio of the peaks of luminance (the ratio of the first peak P1 to the second peak P2) is 1.00:0.53 in FIG. 7, 0.80:1.00 in FIG. 8, and 0.48:1.00 in FIG. 9. As described above, it is possible to adjust the ratio of the luminance LU in the first direction D1 to the luminance LU in the second direction D2 by changing the density of the linear prism 35C.

As described above, according to the present embodiment, it is possible to view two different images from the front of the single liquid crystal display panel 10 and from an oblique direction with respect to the single liquid crystal display panel 10, and to implement the liquid crystal display device 1 that can be made thin and has high efficiency in using light of the backlight 30.

Although the embodiments of the present invention have been described above, the present invention is not limited to the configurations described in the embodiments, and various changes can be made within the technical idea of the present invention. Some or all of the configurations described in the embodiment may be combined and applied.

### REFERENCE SIGNS LIST

1: liquid crystal display device
10: liquid crystal display panel
20: parallax barrier
20A: transmission region
20B: shielding region
30: backlight
31: light guide plate
31A: first linear prism array
31B: second linear prism array
31C: side surface
32: light source
33: reflective film
34: first lens film
34A: third linear prism array
35: second lens film
35A: first region
35B: second region
35C: linear prism
35D: prism pitch
35E: prism width
36: collimated light
100: reflector
θ: angle
D1: first direction
D2: second direction
L1: first light
L2: second light
L2′: reflected light
LU: luminance
P1: first peak
P2: second peak

What is claimed is:

1. A liquid crystal display device comprising:
a liquid crystal display panel;
a parallax barrier that is disposed so as to overlap the liquid crystal display panel, enables a first image to be viewed when the liquid crystal display panel is viewed in a first direction, and enables a second image different from the first image to be viewed when the liquid crystal display panel is viewed in a second direction different from the first direction; and
a backlight disposed on a rear side of the liquid crystal display panel, wherein
the first direction is a normal direction of the liquid crystal display panel,
the backlight includes a light guide plate and a light source that causes the light to enter from a side surface of the light guide plate, and
light emitted from the backlight to the liquid crystal display panel has a peak of luminance within a range of 5° from the first direction and a peak of luminance within a range of 5° from the second direction.

2. The liquid crystal display device according to claim 1, wherein
an angle formed by the first direction and the second direction is in a range of 55° to 65°.

3. The liquid crystal display device according to claim 1, wherein
the backlight includes a reflective film disposed on a rear side of the light guide plate, a first lens film disposed between the light guide plate and the liquid crystal display panel, and a second lens film disposed between the first lens film and the liquid crystal display panel,
collimated light is output from the first lens film,
the second lens film includes a first region from which the entered collimated light is output in the first direction, and a second region in which a linear prism that outputs the entered collimated light in the second direction is disposed, and the first region and the second region are alternately arranged.

4. The liquid crystal display device according to claim 3, wherein
the light guide plate includes a first linear prism array disposed on the reflective film side and extending along the side surface from which the light from the light source enters the light guide plate, and a second linear prism array disposed on the first lens film side and extending in a direction orthogonal to a direction in which the first linear prism array extends, and
the first lens film includes a third linear prism array disposed on the light guide plate side and extending along the side surface from which the light from the light source enters the light guide plate.

5. The liquid crystal display device according to claim 4, wherein
the first linear prism array has an isosceles triangle shape and has a vertex angle of 174° to 178°,
the second linear prism array has an isosceles triangle shape and has a vertex angle of 55° to 65° or a vertex angle of 95° to 100°, and
the third linear prism array has an isosceles triangle shape and has a vertex angle of 66° to 68°.

6. The liquid crystal display device according to claim 3, wherein
the linear prism of the second lens film is disposed on the liquid crystal display panel side, extends along the side surface from which the light from the light source enters the light guide plate, and has a first base angle of 55° to 59° and a second base angle of 83° to 87°.

7. The liquid crystal display device according to claim 3, wherein
a density of the linear prism in the second lens film is in a range of 30% to 70%.
